(19) United States
(12) Patent Application Publication
(10) Pub. No.: US 2023/0421242 A1
(43) Pub. Date: Dec. 28, 2023

(54) RELAY BASE STATION, AND METHOD AND COMPUTER PROGRAM FOR RELAYING COMMUNICATION

(71) Applicant: TOYOTA JIDOSHA KABUSHIKI KAISHA, Toyota-shi (JP)

(72) Inventors: Hideo HASEGAWA, Nagoya-shi (JP); Shinichiroh Fujii, Kawasaki-shi (JP)

(73) Assignee: TOYOTA JIDOSHA KABUSHIKI KAISHA, Toyota-shi (JP)

(21) Appl. No.: 18/333,228

(22) Filed: Jun. 12, 2023

(30) Foreign Application Priority Data
Jun. 22, 2022 (JP) 2022-100718

(51) Int. Cl. H04B 7/155; H04W 64/00

(52) U.S. Cl. CPC H04B 7/15507; H04W 64/006

(57) ABSTRACT

A relay base station mounted on a mobile object includes a processor configured to acquire a state signal indicating the state of the mobile object, enter a relay communication mode to relay wireless communication between a base station and at least one communication terminal when the state signal indicates that a battery of the mobile object is being charged, and enter a travel communication mode to execute communication for travel of the mobile object via the base station when the state signal indicates that the mobile object is traveling.

### FIELD

The present invention relates to a relay base station mounted on a vehicle, a method for relaying communication executed by the relay base station, and a computer program for relaying communication.

### BACKGROUND

A technique to enable communication with a device outside or inside a vehicle with a wireless communication device mounted on the vehicle has been proposed (see Japanese Unexamined Patent Publication JP2015-220668A).

A vehicle-mounted communication device disclosed in JP2015-220668A includes a controller that can execute first wireless communication mode for wireless communication with a device mounted on a vehicle and second wireless communication mode for wireless communication with the outside of the vehicle via an access point. The controller executes the first wireless communication mode when the vehicle is in a drivable state, and stops the first wireless communication mode and executes the second wireless communication mode when the vehicle changes from the drivable state to an undrivable state.

### SUMMARY

It is desired to make more efficient use of a wireless communication device mounted on a vehicle.

It is an object of the present invention to provide a relay base station that can increase the possibility that a communication terminal in an area around a mobile object can access a base station without interfering with travel of the mobile object.

According to an embodiment, a relay base station mounted on a mobile object and configured to relay wireless communication between a base station and at least one communication terminal is provided. The relay base station includes a processor configured to: acquire a state signal indicating the state of the mobile object, enter relay communication mode to relay the wireless communication between the base station and the communication terminal when the state signal indicates that a battery of the mobile object is being charged, and enter travel communication mode to execute communication for travel of the mobile object via the base station when the state signal indicates that the mobile object is traveling.

In the relay base station, the mobile object preferably autonomously travels to take a predetermined action.

According to another embodiment, a method for relaying communication executed by a relay base station mounted on a mobile object and configured to relay wireless communication between a base station and at least one communication terminal is provided. The method includes acquiring a state signal indicating the state of the mobile object, entering relay communication mode to relay the wireless communication between the base station and the communication terminal when the state signal indicates that a battery of the mobile object is being charged, and entering travel communication mode to execute communication for travel of the mobile object via the base station when the state signal indicates that the mobile object is traveling.

According to still another embodiment, a non-transitory recording medium that stores a computer program for relaying communication executed by a relay base station mounted on a mobile object and configured to relay wireless communication between a base station and at least one communication terminal is provided. The computer program includes instructions causing the relay base station to execute a process including acquiring a state signal indicating the state of the mobile object, entering relay communication mode to relay the wireless communication between the base station and the communication terminal when the state signal indicates that a battery of the mobile object is being charged, and entering travel communication mode to execute communication for travel of the mobile object via the base station when the state signal indicates that the mobile object is traveling.

The relay base station according to the present disclosure has an advantageous effect of being able to increase the possibility that a communication terminal in an area around a mobile object can access a base station without interfering with travel of the mobile object.

### BRIEF DESCRIPTION OF DRAWINGS

FIG. 1 schematically illustrates the configuration of a vehicle equipped with a wireless communication device, which is an example of the relay base station.

FIG. 2 illustrates the hardware configuration of the wireless communication device.

FIG. 3 is a functional block diagram of a processor of the wireless communication device.

FIG. 4A is a schematic diagram for explaining a communication relay process.

FIG. 4B is a schematic diagram for explaining a communication relay process.

FIG. 5 is an operation flowchart of the communication relay process.

### DESCRIPTION OF EMBODIMENTS

A relay base station, a method for relaying communication executed by the relay base station, and a computer program for relaying communication will now be described with reference to the attached drawings. The relay base station is mounted on a mobile object, and can enter a relay communication mode to relay wireless communication between a base station and at least one communication terminal and travel communication mode to execute communication for travel of the mobile object via the base station, by switching therebetween. When a state signal indicating the state of the mobile object indicates that a battery of the mobile object is being charged, the relay base station enters the relay communication mode. When the state signal indicates that the mobile object is traveling, the relay base station enters the travel communication mode.

Examples of the mobile object equipped with the relay base station include various vehicles and a robot that can autonomously travel and automatically moves to a charging spot when the remaining power of an onboard battery falls below a predetermined value and that takes a predetermined action. The predetermined action may be, for example, cleaning or an action related to work such as delivery. The following describes an example in which the relay base station is mounted on a vehicle whose battery can be charged from outside.

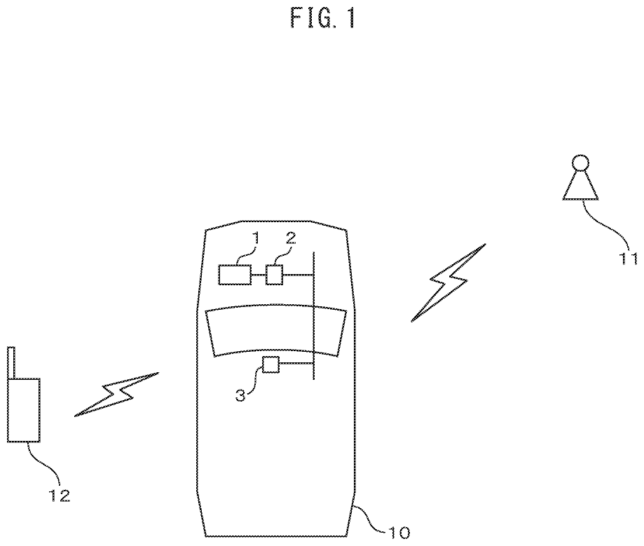

FIG. 1 schematically illustrates the configuration of a vehicle equipped with the relay base station. The vehicle 10 includes a battery 1, an electronic control unit (ECU) 2, and a wireless communication device 3, which is an example of the relay base station. The ECU 2 and the wireless communication device 3 are communicably connected via an in-vehicle network conforming to a standard such as a controller area network. The vehicle 10 may be equipped with a camera (not illustrated) for taking pictures of the surroundings of the vehicle 10, or a distance sensor (not illustrated) for measuring the distances to objects around the vehicle 10, such as a LiDAR sensor. The vehicle 10 may be further equipped with a GPS receiver (not illustrated) for measuring the position of the vehicle 10. The vehicle 10 may be further equipped with a navigation device (not illustrated) that searches for a planned travel route of the vehicle 10 and that navigates so that the vehicle 10 travels along the planned travel route.

The battery 1 is a power source of the vehicle 10, and is composed of, for example, a lithium-ion battery or another type of chargeable and dischargeable battery as well as a control circuit for controlling charge and discharge of the battery included in the battery 1. The battery 1 supplies electric power to devices mounted on the vehicle 10, such as the ECU 2 and the wireless communication device 3. In the case where the vehicle 10 includes a motor (not illustrated) as a power source, electric power may be supplied from the battery 1 to the motor via a circuit for driving the motor, such as an inverter.

In the present embodiment, the battery 1 can be charged from charging equipment outside the vehicle 10 via an interface for charging (not illustrated) provided on the vehicle 10. The control circuit in the battery 1 outputs a signal indicating whether the battery 1 is being charged and the condition of charge or the remaining power of the battery 1 (hereafter a “charging condition signal”) to the ECU 2 at predetermined intervals.

The ECU 2 controls travel of the vehicle 10 or assists a driver in driving the vehicle 10. To achieve this, the ECU 2 includes at least one processor, a memory, and a communication interface for connecting to the in-vehicle network. When a motor is used as a power source of the vehicle 10, the ECU 2 adjusts electric power supplied from the battery 1 to the motor according to an accelerator position. The ECU 2 may detect objects around the vehicle 10 from images obtained by a camera (not illustrated) for taking pictures of the surroundings of the vehicle 10, and control the steering angle, the brake, and the accelerator of the vehicle 10 so that the vehicle 10 will not collide with a detected object. The ECU 2 further detects lane-dividing lines demarcating a lane on which the vehicle 10 is traveling from the images, and controls the steering angle, based on the detected lane-dividing lines, so that the vehicle 10 may keep its lane. Alternatively, when the vehicle 10 is about to deviate from its lane, the ECU 2 may warn the driver of the deviation via a display or another device provided in the vehicle interior.

In addition, the ECU 2 uses information received from a device outside the vehicle 10 via the wireless communication device 3 for controlling the vehicle 10. For example, the ECU 2 may refer to a high-precision map received from a map server (not illustrated) via the wireless communication device 3 to identify a road being traveled by the vehicle 10, and control components of the vehicle 10 so that the vehicle 10 travels at a regulation speed set for the identified road. The ECU 2 may compare features detected from the images, such as lane-dividing lines, with corresponding features represented in the high-precision map to identify the lane on which the vehicle 10 is traveling. When the identified lane differs from a lane leading toward a destination indicated by a planned travel route set by the navigation device (not illustrated), the ECU 2 may control components of the vehicle 10 to move to the lane leading toward the destination. The high-precision map includes various types of information used in automated driving control of the vehicle 10. For example, the high-precision map represents road markings such as lane-dividing lines, signposts, and regulation speeds of individual road sections in a region represented in the high-precision map.

In addition, the ECU 2 may use traffic information received from a traffic information server (not illustrated) via the wireless communication device 3 for controlling travel of the vehicle 10. For example, when the traffic information indicates that the planned travel route includes a section where traffic restrictions are imposed, the ECU 2 may request the navigation device to search for a detour route and makes the vehicle 10 travel along the detour route received from the navigation device.

Further, the ECU 2 manages the remaining power of the battery 1, based on a charging condition signal received from the battery 1. For example, when the remaining power of the battery 1 falls below a predetermined amount, the ECU 2 warns the driver that the battery 1 is running low via a display or another device provided in the vehicle interior. Further, the ECU 2 generates a state signal indicating the state of the vehicle 10 every predetermined period or every time the state of the vehicle 10 changes, and outputs the generated state signal to the wireless communication device 3 via the in-vehicle network. When the charging condition signal received from the battery 1 indicates that the battery 1 is being charged, the ECU 2 includes a value indicating that the battery 1 is being charged, in the state signal. When the vehicle 10 is traveling, the ECU 2 includes a value indicating that the vehicle 10 is traveling, in the state signal. The ECU 2 determines that the vehicle 10 is traveling, when an ignition switch of the vehicle 10 is on. Alternatively, the ECU 2 may determine that the vehicle 10 is traveling, when a shifter position of the vehicle 10 differs from a parking position.

Further, the ECU 2 outputs a signal to be sent to a device outside the vehicle 10, such as a request for delivery of a high-precision map, to the wireless communication device 3 via the in-vehicle network.

The wireless communication device 3, which is an example of the relay base station, can relay wireless communication between a base station 11 placed outside the vehicle 10 and one or more communication terminals 12 in an area around or inside the vehicle 10. In the present embodiment, when a state signal received from the ECU 2 indicates that the battery is being charged, the wireless communication device 3 relays wireless communication between the base station 11 and the communication terminals 12 (relay communication mode). When a state signal received from the ECU 2 indicates that the vehicle 10 is traveling, the wireless communication device 3 executes communication for travel of the vehicle 10 via the base station 11 (travel communication mode). In the following, a signal communicated between the base station 11 and a communication terminal 12 and relayed by the wireless communication device 3 will be referred to as a “relay signal” for convenience of description.

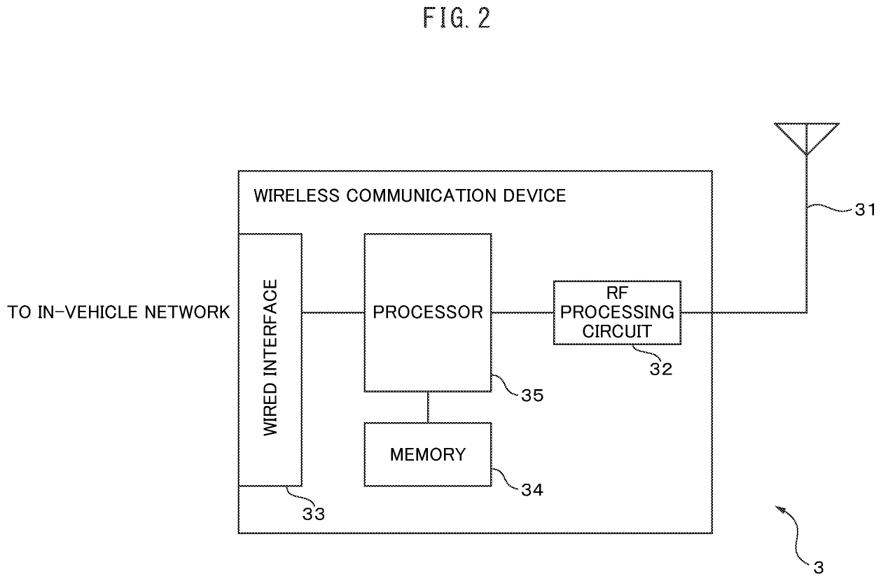

FIG. 2 illustrates the hardware configuration of the wireless communication device 3. The wireless communication device 3 includes an antenna 31, a radio-frequency (RF) processing circuit 32, a wired interface 33, a memory 34, and a processor 35. The RF processing circuit 32, the wired interface 33, the memory 34, and the processor 35 may be mounted on the wireless communication device 3 as separate circuits or a single integrated circuit.

The antenna 31 sends an uplink signal or a downlink relay signal transmitted from the RF processing circuit 32 as a radio signal. Further, the antenna 31 receives a radio signal from the base station 11, converts the signal to an electric signal to generate a downlink signal, and transmits the downlink signal to the RF processing circuit 32. In addition, the antenna 31 receives a radio signal from a communication terminal 12, converts the signal to an electric signal to generate an uplink relay signal, and transmits the relay signal to the RF processing circuit 32. The antenna 31 may include an antenna for communication with the base station 11 and an antenna for communication with the communication terminals 12 separately.

The RF processing circuit 32 converts an uplink signal or a downlink relay signal received from the processor 35 to an analog signal, and then superposes the analog signal on a carrier wave having a radio frequency specified by the processor 35. The RF processing circuit 32 amplifies the uplink signal or the relay signal superposed on the carrier wave to a desired level with a high-power amplifier (not illustrated), and transmits the amplified uplink signal or relay signal to the antenna 31.

Further, the RF processing circuit 32 amplifies a downlink signal or an uplink relay signal received from the antenna 31 with a low-noise amplifier (not illustrated). The RF processing circuit 32 multiplies the amplified downlink signal or relay signal by a periodic signal having an intermediate frequency to convert the frequency of the downlink signal or the relay signal from the radio frequency to a baseband frequency. The RF processing circuit 32 executes analog-to-digital conversion of the downlink signal or the relay signal having a baseband frequency, and then passes the signal to the processor 35.

The wired interface 33, which is an example of an in-vehicle communication unit, includes an interface circuit for connecting the wireless communication device 3 to the in-vehicle network. In other words, the wired interface 33 is connected to the ECU 2 via the in-vehicle network. The wired interface 33 passes a state signal received from the ECU 2 to the processor 35, and outputs information used for travel of the vehicle 10 (e.g., a high-precision map or traffic information) received from the processor 35 to the ECU 2 via the in-vehicle network.

The memory 34, which is an example of a storage unit, includes, for example, a read-only nonvolatile semiconductor memory and a rewritable nonvolatile or volatile semiconductor memory. The memory 34 stores various types of information for communication with the base station 11 and the communication terminals 12 and various programs executed by the wireless communication device 3. In addition, the memory 34 may temporarily store signals received from the base station 11, the communication terminals 12, or the ECU 2 and signals to be sent to the base station 11, the communication terminals 12, or the ECU 2.

The processor 35 includes one or more central processing units (CPUs) and a peripheral circuit thereof. The processor 35 may further include another operating circuit, such as a logic-arithmetic unit or an arithmetic unit. The processor 35 executes a process related to wireless communication between the base station 11 and the wireless communication device 3 and relay communication between the base station 11 and the communication terminals 12.

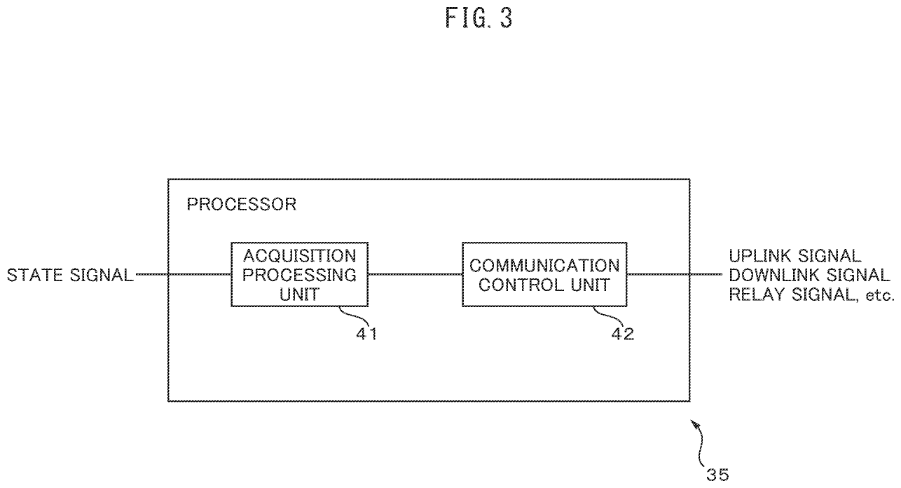

FIG. 3 is a functional block diagram of the processor 35. The processor 35 includes an acquisition processing unit 41 and a communication control unit 42. These units included in the processor 35 are functional modules, for example, implemented by a computer program executed by the processor 35, or may be dedicated operating circuits embedded in the processor 35.

The acquisition processing unit 41 acquires a signal from the ECU 2, in particular, a state signal via the wired interface 33, and passes the received signal to the communication control unit 42.

The communication control unit 42 executes a process related to communication mode, which is the relay communication mode or the travel communication mode, depending on the latest state signal received from the ECU 2. In the present embodiment, when the state signal indicates that the battery 1 is being charged, the relay communication mode is entered. When the state signal indicates that the vehicle 10 is traveling, the travel communication mode is entered.

When in the relay communication mode, the communication control unit 42 executes various processes for wireless communication between the base station 11 and the communication terminals 12 and the wireless communication device 3 in accordance with a predetermined wireless communication standard. The predetermined wireless communication standard may be, for example, a wireless communication standard related to the “fifth-generation mobile communication system” formulated by the 3rd Generation Partnership Project (3GPP, registered trademark) or a standard related to another mobile communications system. Examples of the processes for wireless communication include establishment of communication between the base station 11 and the communication terminals 12 and the wireless communication device 3, allocation of radio resources, and uplink power control. In addition, the communication control unit 42 outputs a downlink relay signal to the RF processing circuit 32 so that the relay signal received from the RF processing circuit 32 is sent to a communication terminal 12, using a radio resource allocated for wireless communication with the communication terminal 12. Similarly, the communication control unit 42 outputs an uplink relay signal to the RF processing circuit 32 so that the relay signal received from the RF processing circuit 32 is sent to the base station 11, using a radio resource allocated for wireless communication with the base station 11.

When in the travel communication mode, the communication control unit 42 executes various processes for wireless communication between the base station 11 and the wireless communication device 3 in accordance with a predetermined wireless communication standard. In addition, the communication control unit 42 generates an uplink signal including a signal to be sent to a device outside the vehicle 10 (e.g., a request for delivery of a high-precision map) received from the ECU 2, and executes an encoding process, such as error-correction coding, on the uplink signal. The communication control unit 42 further modulates the uplink signal in accordance with a predetermined modulation scheme, and outputs the modulated uplink signal to the RF processing circuit 32. In addition, the communication control unit 42 demodulates a downlink signal received from the RF processing circuit 32, executes error-correction decoding, and extracts information used for travel of the vehicle 10, such as a high-precision map or traffic information, from the decoded downlink signal. The communication control unit 42 outputs the information used for travel of the vehicle 10 extracted from the downlink signal to the ECU 2 via the wired interface 33.

The wireless communication device 3 preferably stops communication for travel of the vehicle 10 while in the relay communication mode, but may execute communication for travel of the vehicle 10. When the wireless communication device 3 executes communication for travel of the vehicle 10 while in the relay communication mode, the communication control unit 42 preferably gives a higher priority to relay communication between the base station 11 and the communication terminals 12 than to communication for travel of the vehicle 10.

The wireless communication device 3 preferably stops relay communication between the base station 11 and the communication terminals 12 while in the travel communication mode. This enables the wireless communication device 3 to prevent delay of communication when receiving information used for travel of the vehicle 10 from another device via the base station 11, so that travel of the vehicle 10 is not interfered with.

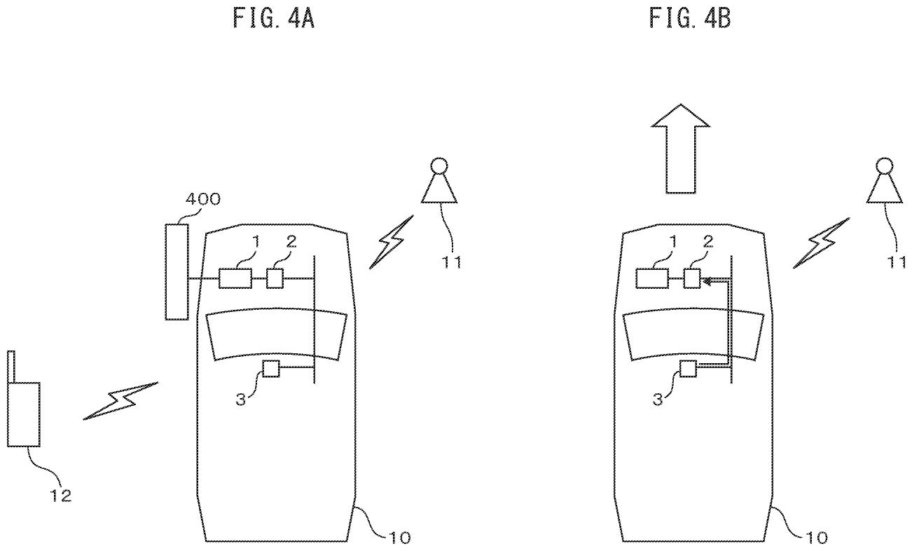

FIGS. 4A and 4B are schematic diagrams for explaining a communication relay process. In the example illustrated in FIG. 4A, the vehicle 10 is parked at a charging station 400, and the battery 1 of the vehicle 10 is being charged with charging equipment of the charging station 400. Hence, the wireless communication device 3 executes the relay communication mode, and relays wireless communication between the base station 11 and a communication terminal 12 in an area around the vehicle 10. In this way, the communication terminal 12 can communicate with the base station 11 by wireless via the wireless communication device 3 even if the communication terminal 12 cannot receive a radio signal directly from the base station 11.

In the example illustrated in FIG. 4B, the vehicle 10 is traveling, and thus the wireless communication device 3 enters the travel communication mode. The wireless communication device 3 sends and receives various types of information used for travel of the vehicle 10 to and from a device (not illustrated) outside the vehicle 10 via the base station 11. The wireless communication device 3 outputs the received information to the ECU 2.

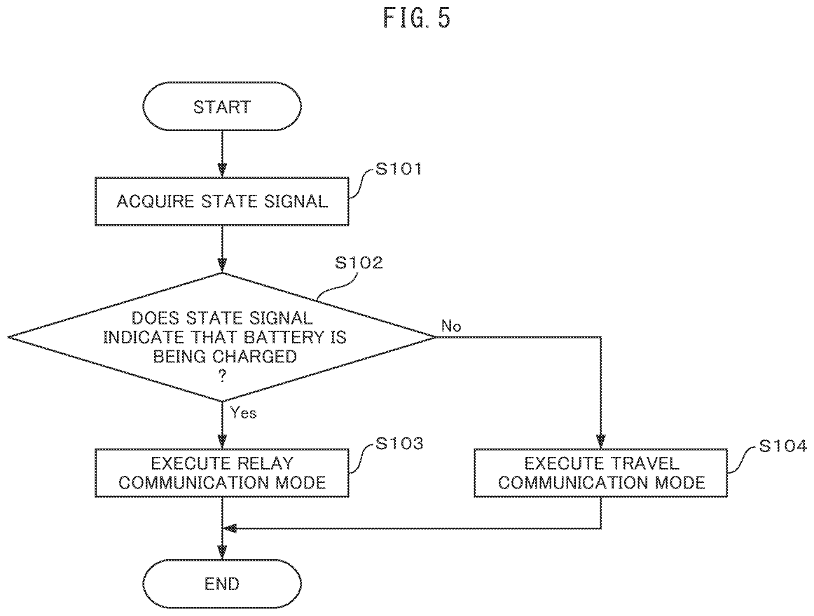

FIG. 5 is an operation flowchart of the communication relay process. The processor 35 executes the communication relay process in accordance with this operation flowchart at predetermined intervals.

The acquisition processing unit 41 of the processor 35 acquires a state signal from the ECU 2 via the in-vehicle network and the wired interface 33 (step S101). Upon acquisition of a state signal, the communication control unit 42 of the processor 35 determines whether the state signal indicates that the battery 1 is being charged (step S102). When the state signal indicates that the battery 1 is being charged (Yes in step S102), the communication control unit 42 enters the relay communication mode (step S103). When the state signal indicates that the vehicle 10 is traveling (No in step S102), the communication control unit 42 enters the travel communication mode (step S104). After step S103 or S104, the processor 35 terminates the relay communication process.

As has been described above, the relay base station mounted on a mobile object enters the relay communication mode when a state signal indicating the state of the mobile object indicates that a battery of the mobile object is being charged. When the state signal indicates that the mobile object is traveling, the relay base station enters the travel communication mode. In this way, the relay base station relays communication between a communication terminal and a base station, making use of timing of battery charging, at which travel of the mobile object is not interfered with even if no communication resource is allocated. For this reason, the relay base station can increase the possibility that a communication terminal in an area around the mobile object can access a base station without interfering with travel of the mobile object.

According to a modified example, the state of the vehicle 10 may be managed by a server (not illustrated) placed outside the vehicle 10 and connected to a base station 11 via a core network. In this case, the vehicle 10 may be equipped with a wireless communication terminal (not illustrated) connected to the in-vehicle network and a near-field communication circuit (not illustrated) conforming to a predetermined near-field communication standard, separately from the wireless communication device 3. The wireless communication standard to which the wireless communication terminal conforms may differ from and restrict communication speed more than the wireless communication standard to which the wireless communication device 3 conforms. The predetermined near-field communication standard may be, for example, Bluetooth (registered trademark) or ZigBee (registered trademark). In this example, the wireless communication device 3 need not be connected to the in-vehicle network. Thus the wireless communication device 3 preferably includes a near-field communication circuit conforming to a predetermined near-field communication standard, instead of the wired interface 33. In this case, the ECU 2 sends a state signal to the server via the wireless communication terminal at predetermined intervals. The wireless communication device 3 receives a state signal from the server via the base station 11 at predetermined intervals. In addition, the wireless communication device 3 transfers information used for travel of the vehicle 10 received in the travel communication mode to the ECU 2 via the near-field communication circuit. According to this modified example, the wireless communication device 3 can execute the same process and have the same advantageous effect as those in the embodiment even if the wireless communication device 3 is not connected to the in-vehicle network.

As described above, the mobile object equipped with the relay base station according to the embodiment or modified example may be a robot that can autonomously travel and automatically moves to a charging spot when the remaining power of an onboard battery falls below a predetermined value and that takes a predetermined action. Mounting the relay base station on such a mobile object enables efficient use of the mobile object even during charging, when the mobile object cannot take a predetermined action.

In some cases, there may be multiple charging spots, such as the charging station illustrated in FIG. 4A. In such cases, it is preferable to select a charging spot used for a mobile object equipped with the relay base station to charge the battery so as to increase the area where relay communication is applicable or the number of communication terminals 12 to which relay communication is applicable. Thus, according to another modified example, for each mobile object equipped with the relay base station, a server (not illustrated) connected to a base station 11 via a core network selects a charging spot to be used by the mobile object, and notifies the mobile object of the selected charging spot. In this case, for each mobile object equipped with the relay base station, the server stores a list indicating the positions of charging spots that the mobile object can use and their available times of day (hereafter a “spot list”). When receiving a remaining power signal indicating that the remaining battery power is not greater than a predetermined amount from a mobile object via the relay base station, the server selects a charging spot whose available times of day include the current time by referring to the spot list. The server sends an instruction signal for moving the mobile object to the selected charging spot to the mobile object via the base station 11 and the relay base station. The instruction signal includes the position of the selected charging spot. When receiving an instruction signal, the mobile object autonomously moves to the charging spot indicated by the received instruction signal. For example, in the above-described example, when receiving an instruction signal via the base station 11 and the wireless communication device 3, the ECU 2 of the vehicle 10 executes automated driving control of the vehicle 10 so that the vehicle 10 moves to the position of the charging spot indicated by the received instruction signal. Alternatively, the ECU 2 may notify the driver of the position of the charging spot indicated by the received instruction signal via a user interface provided in the interior of the vehicle 10. The vehicle 10 may then move to the charging spot by the driver's manual driving.

The server determines a charging spot to be selected, based on indices such as the numbers of mobile objects at respective charging spots, whether there is a mobile object that is about to finish charging, or geographical distribution of communication terminals 12 connected to one of one or more base stations. To this end, the server calculates, for each charging spot, a rating that increases with the area where relay communication is applicable or the number of communication terminals 12 to which relay communication is applicable, based on at least one of indices like those mentioned above. The server then selects the charging spot having a maximum rating. More specifically, the server gives a higher rating to a charging spot where fewer mobile objects are being charged. This is because a charging spot where fewer mobile objects are being charged has fewer relay base stations that can execute relay communication, and thus has a higher possibility that there is a communication terminal that cannot use relay communication. The server also gives a high rating to a charging spot where there is a mobile object that is about to finish charging. This is because the mobile object whose charging is finished is highly likely to move from the charging spot, which may lead to interruption of relay communication that is being executed by the relay base station mounted on the mobile object whose charging is finished. The server can calculate the rating by receiving a signal indicating a predicted time until charging is finished or remaining battery power from each mobile object being charged via the relay base station and a base station. For each charging spot, the server may further count the number of communication terminals 12 within a predetermined distance of the charging spot by referring to the geographical distribution of communication terminals 12 connected to one of one or more base stations. The one or more base stations are preferably “macro base stations,” and may include not only the base station 11 but also another base station conforming to a wireless communication standard different from the wireless communication standard to which the base station 11 conforms. The server gives a higher rating to a charging spot having more communication terminals 12 within the predetermined distance. In this case, the server receives information indicating the numbers of registered communication terminals 12 in respective cells and the geographical areas of the cells from individual base stations at predetermined intervals. For each charging spot, the server then determines the total number of communication terminals 12 registered in cells overlapping the region within the predetermined distance of the charging spot, as the number of communication terminals 12 within the predetermined distance of the charging spot. When calculating the rating on the basis of multiple indices, the server determines the sum of individual ratings calculated for the respective indices as the rating anew.

According to this modified example, the communication system including the relay base station can increase the area where relay communication is applicable or the number of communication terminals 12 to which relay communication is applicable.

According to still another modified example, while the battery of a mobile object equipped with the relay base station is being charged, the relay base station may set the area to which the relay communication mode is applied, based on the number of other mobile objects being charged from the charging spot of the mobile object. For example, the relay base station may limit directivity of radio signals outputted from the antenna of the relay base station or decrease power of radio signals as the number of other mobile objects being charged increases. To this end, the relay base station counts the number of relay base stations that can directly communicate with each other, as the number of other mobile objects being charged.

The computer program for causing a computer to achieve the functions of the units included in the processor of the relay base station according to the embodiment or modified examples may be provided in a form recorded on a computer-readable storage medium. The computer-readable storage medium may be, for example, a magnetic medium, an optical medium, or a semiconductor memory.

As described above, those skilled in the art may make various modifications according to embodiments within the scope of the present invention.

What is claimed is:

1. A relay base station mounted on a mobile object and configured to relay wireless communication between a base station and at least one communication terminal, the relay base station comprising a processor configured to:
acquire a state signal indicating the state of the mobile object,
enter a relay communication mode to relay the wireless communication when the state signal indicates that a battery of the mobile object is being charged, and
enter a travel communication mode to execute communication for travel of the mobile object via the base station when the state signal indicates that the mobile object is traveling.

2. The relay base station according to claim 1, wherein the mobile object autonomously travels to take a predetermined action.

3. A method for relaying communication executed by a relay base station mounted on a mobile object and configured to relay wireless communication between a base station and at least one communication terminal, the method comprising:
acquiring a state signal indicating the state of the mobile object;
entering a relay communication mode to relay the wireless communication when the state signal indicates that a battery of the mobile object is being charged; and
entering a travel communication mode to execute communication for travel of the mobile object via the base station when the state signal indicates that the mobile object is traveling.

4. A non-transitory recording medium that stores a computer program for relaying communication executed by a relay base station mounted on a mobile object and configured to relay wireless communication between a base station and at least one communication terminal, the computer program causing the relay base station to execute a process comprising:
acquiring a state signal indicating the state of the mobile object;
entering a relay communication mode to relay the wireless communication when the state signal indicates that a battery of the mobile object is being charged; and
entering a travel communication mode to execute communication for travel of the mobile object via the base station when the state signal indicates that the mobile object is traveling.
